(19) United States
(12) Patent Application Publication
(10) Pub. No.: US 2024/0426560 A1
(43) Pub. Date: Dec. 26, 2024

(54) Device for dispensing heat-transfer fluid

(71) Applicant: SOGEFI AIR & COOLING, SAINT MARTIN DE FRAIGNEAU (FR)

(72) Inventors: Richard KOMURIAN, TURCKHEIM (FR); Nicolas BECKER, PORTE-DU-RIED (FR); Yannick PAPI, BUHL (FR); Hervé MICHEL, CHATENOIS (FR)

(21) Appl. No.: 18/692,274

(22) PCT Filed: Sep. 22, 2022
(86) PCT No.: PCT/EP2022/076391

§ 371 Date: Mar. 14, 2024

(30) Foreign Application Priority Data
Sep. 24, 2021 (FR) FR21 10058

(51) Int. Cl. F28F 1/02

(52) U.S. Cl. CPC F28F 1/022; F28F 1/025

(57) ABSTRACT

A device for dispensing heat-transfer fluid at cooling plates has at least a heat-transfer fluid pipe that includes a dispensing port positioned opposite a circulation port of a cooling plate and a bearing surface with a shape that is complementary to the surface of the cooling plate that has a circulation port. The bearing surface surrounds a portion of the distribution port of the pipe. The heat-transfer fluid pipe has a seal positioned along the bearing surface of the pipe that is configured to seal the junction of the dispensing port with a cooling plate and also a means for attaching the pipe to the cooling plate.

The present invention relates to the field of battery thermal regulation devices and more particularly to the field of devices for dispensing heat-transfer fluid for the thermal regulation of battery cells.

Battery cooling conventionally involves cooling plates positioned in contact against the surface of the batteries that are intended to be cooled. Each of these cooling plates has a hollow structure inside which a heat-transfer fluid is circulated. The contact of a cooling plate against the surface of a battery makes it possible to optimize the heat exchanges between the two surfaces. The heat-transfer fluid being displaced inside a cooling plate then allows an extraction of the heat transferred from a battery to the cooling plate. The circulation of the heat-transfer fluid then makes it possible to apply an optimized maintenance of the heat exchanges between a battery and the cooling plate with a continuous extraction of the heat.

Inside the cooling plates, the heat-transfer fluid is displaced between two orifices, inlet and outlet, disposed at at least one end of the plates. The heat-transfer fluid is distributed between different cooling plates disposed parallel to one another by dispensing ducts which, on the one hand, supply the inlet orifices of each of the cooling plates and, on the other hand, recover the heat-transfer fluid at the outlet orifices of these plates. These supply and extraction dispensing ducts conventionally have a rectilinear structure of substantially circular section, which comprises a plurality of orifices, the respective forms of which complement that of the inlet and outlet orifices borne by each of the plates at at least one of its ends. The dispensing ducts are thus welded to each of the plates at the periphery of each of the inlet and outlet orifices. However, such a method of assembling the dispensing duct with the cooling plates, while it offers notable effectiveness in terms of seal-tightness, also presents a user wanting to intervene at this join with difficulties, notably in the context of a maintenance operation. Indeed, through its specific position between the two assembled elements that are an orifice of the dispensing duct and an orifice of the cooling plate, the weld presents a defect of accessibility which complicates the separation of these two elements. Moreover, a weld demands a detachment of these elements with a rupturing of the join and/or with a breaking of the dispensing duct. Also, when a user has to perform the replacement of a broken duct because of the weld, such a welded assembly does not allow a rapid and easy separation. Consequently, the user is forced to remove all of the broken element to replace it with a new element, even though this break of the duct might be one-off and highly localised.

The aim of the present invention is to mitigate these drawbacks by proposing a solution for assembling the dispensing duct with the cooling plate which makes it possible to carry out an installation and a separation that is made easier while guaranteeing a seal-tightness of the join between these two elements without the risk of affecting the dispensing duct.

Thus, the subject of the invention is a dispensing device for dispensing heat-transfer fluid at circulation orifices of cooling plates, characterized in that the device comprises at least:
one heat-transfer fluid duct comprising at least:
   one dispensing orifice configured to be positioned facing at least one circulation orifice of a cooling plate,
   one bearing surface configured to be of a form complementing the portion of the surface of the cooling plate which bears at least one circulation orifice, this bearing surface surrounding at least a part of the dispensing orifice of the duct,
one seal positioned along at least a part of the bearing surface of the duct, this seal being configured to seal the join of the dispensing orifice of the duct with a cooling plate,
a fixing means for fixing the duct to the surface of a cooling plate.

The invention relates also to an assembly which comprises at least one dispensing device according to the invention fixed to at least one cooling plate.

The invention will be better understood, from the following description, which relates to different preferred embodiments, given as nonlimiting examples, and explained with reference to the attached schematic drawings, in which:

FIG. 1 illustrates a schematic representation according to an exploded view of an exemplary assembly combining a heat-transfer fluid dispensing device according to the invention associated with a cooling plate.

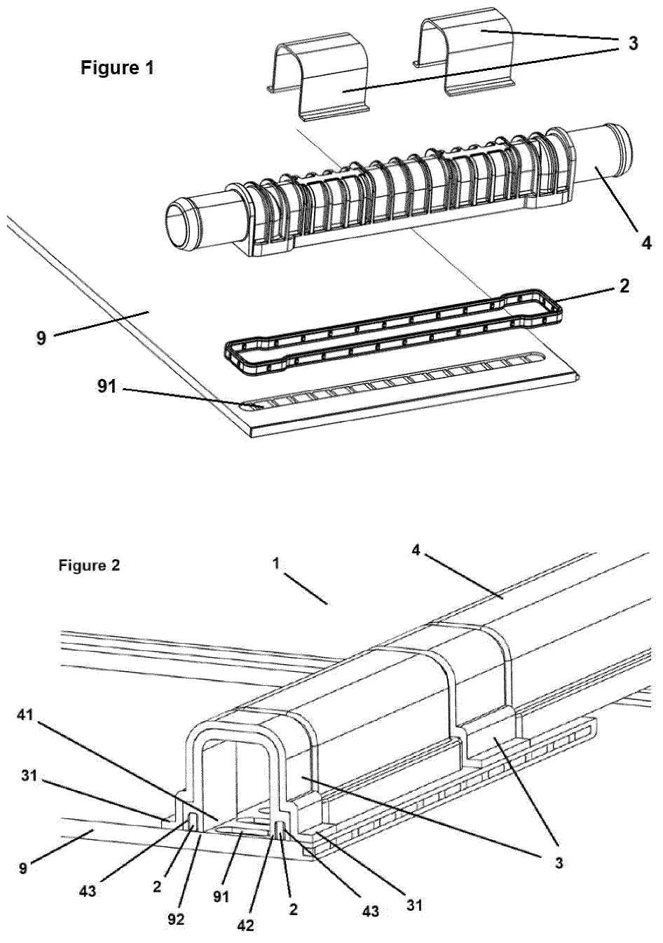

FIG. 2 illustrates a schematic representation of a first exemplary implementation of a heat-transfer fluid dispensing device according to the invention associated with a cooling plate.

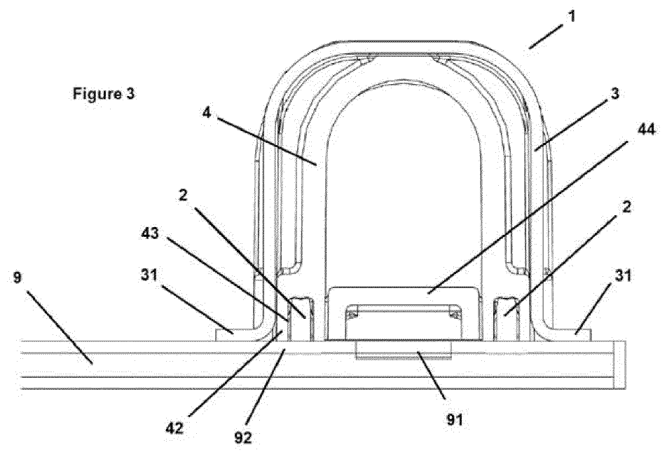

FIG. 3 illustrates a schematic representation according to a sectional view of a second exemplary implementation of a heat-transfer fluid dispensing device according to the invention associated with a cooling plate.

The invention relates to a dispensing device 1 for dispensing heat-transfer fluid at circulation orifices 91 of cooling plates 9, characterized in that the device comprises at least:
one heat-transfer fluid duct 4 comprising at least:
   one dispensing orifice 41 configured to be positioned facing at least one circulation orifice 91 of a cooling plate 9,
   one bearing surface 42 configured to be of a form complementing the portion of the surface 92 of the cooling plate 9 which bears at least one circulation orifice 91, this bearing surface 42 surrounding at least a part of the dispensing orifice 41 of the duct 4, p1 one seal 2 positioned along at least a part of the bearing surface 42 of the duct 4, this seal 2 being configured to seal the join of the dispensing orifice 41 of the duct 4 with a cooling plate 9,
a fixing means 3 for fixing the duct 4 to the surface of a cooling plate 9.

The dispensing device 1 according to the invention is thus produced by the combination of a dispensing duct 4 with a seal 2 and a fixing means 3 that are arranged to cooperate with the surface of a cooling plate 9 at a circulation orifice 91.

The dispensing device 1 is configured to apply a tight join with the cooling plate 9 via a seal 2 notably positioned compressed between the heat-transfer fluid dispensing duct 4 and the surface of the cooling plate 9. The tight seal 2 is produced in an elastic material, for example a material of silicone or rubber type. The fixing means 3 is configured to keep the duct 4 joined to the cooling plate 9 such that at least a part of the peripheral edge of the dispensing orifice 41 of the duct 4 is pressed against a surface of the tight seal 2, an opposite surface of the tight seal 2 being pressed against a part of the peripheral edge of the circulation orifice 91 of a cooling plate 9. This sealing by compression of the seal 2 between the surfaces of the duct 4 and of the cooling plate 9 at the periphery of the dispensing 41 and circulation 91 orifices allows, by virtue of the elasticity of the seal 2, a relative flexibility of the positioning between them of the two assembled elements, despite the hold ensured by the fixing means 3. Furthermore, the seal 2 is produced in the form of a substantially circular structure, for example annular, so as to allow a peripheral partitioning of the space or of the volume which separates the two dispensing 41 and circulation 91 orifices, respectively borne by the dispensing duct 4 and the surface of the cooling plate 9. Through such a partitioning of the space or of the volume between the dispensing duct 4 and the surface of the cooling plate 9 at their respective orifices 41, 91, it is not necessary for these orifices 41, 91 to have outlines and forms which are strictly identical. Indeed, the outlines and forms of the dispensing 41 and circulation 91 orifices are likely to present differences provided that each of these two orifices 41, 91 disposed facing one another remains positioned within the inner edge of the tight seal 2.

The fixing means 3 is preferentially configured to provide a reversible assembly of the duct 4 with the surface of a cooling plate 9. This reversibility of the fixing means 3 thus allows an easier separation of the joined elements, notably when one of the two elements has to be replaced. According to different alternatives, the fixing means 3 can be independent of the duct 4 and of the cooling plate 9 or, on the contrary, be fixed with one or other of these two elements.

According to an exemplary construction relating to a particular variant of the dispensing device 1 according to the invention, the bearing surface 42 of the duct 4 at which the seal 2 is positioned comprises a recess 43 capable of receiving at least a part of the seal 2. According to this variant, the bearing surface 42 of the duct 4 which exerts a compression of the seal 2 has a cavity producing a recess 43 of form and outline substantially complementing the form and the outline of the seal 2. According to a specific construction feature, at least a part of the dimensions of this recess 43 is selected to allow a deformation of the seal 2 by compression inside the recess 43. According to an alternative, even possibly complementary, specific construction feature, at least a part of the dimensions of this recess 43 is selected to keep a part of the seal 2 compressed when the seal 2 is positioned therein. According to this specific construction feature, the part of the seal 2 compressed corresponds substantially to the part of this seal 2 inserted into the recess 3. This compression of the part of the inserted seal 2 makes it possible to apply a pinching of the seal 2 by a part of the recess 43, such that the seal 2 is able to be held in position inside the recess 43. The pinching and/or the compression of the inserted seal 2 by opposite edges of the recess 43 is performed in a plane substantially at right angles to the axis of compression of the seal 2 between the dispensing duct 4 and the cooling plate 9. It should be noted that the depth of this cavity producing a recess 43 is defined such that, when the seal 2 is compressed, the thickness of the seal 2 remains sufficient for the seal 2 to exceed the level formed by the bearing surface 42.

According to an exemplary construction relating to another particular variant of the dispensing device 1 according to the invention and that can be combined with the features of the variant previously set out, the bearing surface 92 of the cooling plate 9 at which the seal 2 is positioned comprises a recess 93 capable of receiving at least a part of the seal 2. It should be noted that, in the context of this particular construction variant, the recess 93 is produced by a cavity of form and outline substantially complementing the form and the outline of the seal 2. This cavity forming the recess 93 is then able to adopt characteristics in its construction and its interactions with the seal 2 which reproduce substantially similarly, if not identically, the characteristics of the cavity previously detailed and relate to the bearing surface 42 of the duct 4. It should be noted that the depth of this cavity producing a recess 93 is defined such that, when the seal 2 is compressed, the thickness of the seal 2 remains sufficient for the seal 2 to exceed the level formed by the bearing surface 92 of the cooling plate 9.

Similarly according to an exemplary construction relating to another particular variant of the dispensing device 1 according to the invention, the seal 2 cooperates with the dispensing duct 4 and the cooling plate 9, such that each of these two elements comprises a respective cavity which, positioned facing one another, produce two parts of a recess inside which two parts of the seal 2 are positioned. The aggregate of the depths of each of these two cavities positioned facing one another is defined such that, when the seal 2 is compressed, the thickness of the seal 2 remains sufficient to prevent the respective bearing surfaces 42, 92 of the dispensing duct 4 and of the cooling plate 9 from not producing a direct contact but remaining spaced apart from one another by the seal 2.

According to an exemplary construction relating to another particular variant of the dispensing device 1 according to the invention and that can be combined with the features of the variants previously set out, at least a portion of the seal 2 is produced in ethylene-propylene-diene monomer, also called EPDM, in hydrogenated butadiene-acrylonitrile, also called HNBR and/or in silicone. The ethylene-propylene-diene monomer or EPDM, like the materials preferentially selected to contribute to the production of the seal 2, has the property of having a good chemical resistance to a compound such as glycol, a fluid that exhibits particularly advantageous heat-transfer properties. Moreover, these materials also have elastic properties which ensure that the seal 2 maintains a withstand strength over time, notably faced with the compression forces exerted between the duct 4 and the cooling plate 9.

According to an exemplary construction relating to another particular variant of the dispensing device 1 according to the invention and that can be combined with the features of the variants previously set out, in section at a dispensing orifice 41 intended to be positioned facing a cooling plate 9, the duct 4 has a “U” form comprising a portion with a substantially semi-circular arrangement open toward the dispensing orifice 41 that is intended to be partitioned by the surface of the cooling plate 9. According to this construction variant, the opening which forms a dispensing orifice 41 is positioned on the peripheral surface of the duct 4 according to a particular arrangement to allow easier construction and optimized cooperation with a cooling plate 9. This duct 4 thus has, at portions of its length intended to be in contact with a cooling plate 9, that is say notably at portions of its length positioned on the periphery of the dispensing orifice 41, an arrangement which, in a plane in section substantially at right angles to the axis of the flow in the duct 4, has a design form that is simple to produce. This arrangement according to a “U” form, that is to say comprising, on the one hand, a partitioned side and, on the other hand, an open side which produces the dispensing orifice 41, makes it possible to obtain two portions of the bearing surface 42 at the end of the legs of the “U” that can be disposed on either side of the dispensing orifice 41. Furthermore, an arrangement in which the legs of the “U” have heights that are substantially similar overall to the length of the portion of duct 4 adds the advantage of allowing an easier positioning of the duct 4 against the surface of a cooling plate 9. It should be noted that, if, in each of the examples illustrated by the different figures, the partitioned side has a rounded arrangement, a construction having an alternative configuration, for example with different angles, can be envisaged without in any way departing from the device of the invention.

According to an exemplary construction relating to another particular variant of the dispensing device 1 according to the invention and that can be combined with the features of the variants previously set out, in section at a portion of the duct 4 not bearing any dispensing orifice 41, the duct 4 has an arrangement that is totally partitioned, even substantially circular. Such a portion of duct 4 is produced notably at parts of the duct 4 that are intended to be positioned, with respect to the direction of the planned flow in the duct 4, upstream or downstream of the parts of the duct 4 which interact with the cooling plate 9. The form of these partitioned portions of the duct 4, in a plane in section substantially at right angles to the axis of the flow in the duct 4, can be of any type. However, according to a specific exemplary construction, when the dispensing duct 4 has a singular structure, the form adopted by the partitioned portions of the duct 4 is preferentially configured to apply a continuity of surface with the portions of the duct 4 which bear dispensing orifices 41 in a majority part of the surface of the duct 4.

According to an exemplary construction relating to another particular variant of the dispensing device 1 according to the invention and that can be combined with the features of the variants previously set out, the fixing means 3 comprises a plurality of snap-fitting parts, of clamps, or of screws distributed over the length of the dispensing duct 4 such that each part of the fixing means 3 applies an anchoring of the dispensing orifice 41 with the surface of the cooling plate 9. Depending on the specific nature of the fixing means, the anchoring of the duct 4 to the cooling plate 9 is likely to involve particular arrangements or reliefs at structures or surfaces of each of these two joined elements 4, 9. Thus, by way of example, the fixing means 3 comprises at least one tab bearing a fixing interface 31 positioned on each side of the axis of the duct 4 and level with the bearing surface of the duct 4. This duct 4 is then likely to comprise one or more tabs disposed over its length which have interfaces substantially complementing the surface of the cooling plate 9 and are arranged to be passed through by through-parts, such as screws, to cooperate with tapped interfaces borne by the surface of the cooling plate 9.

According to an exemplary construction relating to another particular variant of the dispensing device 1 according to the invention and that can be combined with the features of the variants previously set out, the fixing means 3 comprises a structure having the form of a staple arranged to surround at least a portion of the duct 4 at a section, each of the two ends of the staple comprising a fixing interface 31 configured to interact with at least a part 92 of the surface of the cooling plate 9 on which the fixing of the duct 4 is done. According to this variant construction, the inner edge produced by the surface situated between the legs of the staple preferentially has an arrangement of substantially similar, even identical, form, to complement the part of the perimeter of the dispensing duct 4 with which the staple of the fixing means 3 cooperates. This complementarity of form allows the staple of the fixing means 3 to apply a positioning and holding of the duct 4 which are optimized by best closely following the outer surface of the duct 4. Each of the fixing interfaces 31 positioned at the ends of the staple of the fixing means 3 applies an anchoring with the surface of the cooling plate 9 by cooperation with one or more snap-fitting parts, clamps, or screws which interact with particular arrangements or reliefs borne by the structure or the surfaces of the cooling plate 9 and/or of the ends of the staple of the fixing means 3. According to a specific exemplary production of this construction variant, the fixing means 3 comprises at least one tab bearing a fixing interface 31 positioned on each side of the axis of the duct 4 and level with the bearing surface of the duct 4. Thus, the ends of the staple of the fixing means 3 are likely to comprise one or more tabs which have interfaces substantially complementing the surface of the cooling plate 9 and are arranged to be passed through by through-parts, such as screws, to cooperate with tapped interfaces borne by the surface of the cooling plate 9.

According to an exemplary construction relating to another particular variant of the dispensing device 1 according to the invention and that can be combined with the features of the variants previously set out, the heat-transfer fluid duct 4 comprises a covering structure 44 for covering at least one circulation orifice 91 of a cooling plate 9, this covering structure 44 comprising a plurality of dispensing orifices 41. According to this construction variant, the circulation orifice 91 of the cooling plate 9 comprising a lengthwise arrangement, the duct 4 is positioned at the circulation orifice 91 such that the axis of the duct 4 is disposed in the length of the circulation orifice 91. The covering structure 44 thus allows the duct 4 to apply a partial shutting of the circulation orifice 91 by positioning one or more dispensing orifices 41 of different respective dimensions so as to optimize the dispensing or the extraction of the heat-transfer fluid between the duct 4 and the cooling plate 9. Thus, the covering structure 44, on the one hand, has a dimensioning at least greater than the surface of the circulation orifice 91 of the cooling plate 9 and, on the other hand, preferentially comprises several through-openings along its surface, each defining a dispensing orifice 41 of respective form and dimension. Preferentially, this covering structure 44 is structurally independent of the rest of the structure of the dispensing duct 4. This covering structure 44 can thus be mounted on the surface of the cooling plate 9 independently of the fixing of the dispensing duct 4 on this same plate 9. Alternatively, the covering structure 44 is held at the surface of the circulation orifice 91 of the cooling plate 9 by pinching or compression of the dispensing duct 4 bearing against the cooling plate 9. Similarly, this covering structure 44 can be assembled with the dispensing duct 4 before these two elements are mounted on the surface of the cooling plate 9.

The invention relates also to an assembly, characterized in that it comprises at least one dispensing device 1 according to the invention fixed to at least one cooling plate 9.

According to an exemplary construction relating to a particular variant of the assembly according to the invention, at least one cooling plate 9 is associated with a dispensing device 1 positioned at the circulation orifices 91 of each of its ends. According to this variant, on the one hand, a first dispensing device 1 is mounted on the cooling plate 9 so as to supply the internal volume of the plate 9 with heat-transfer fluid and, on the other hand, a second dispensing device 1 is mounted at another part of the cooling plate 9 so as to extract the heat-transfer fluid from the inside of the plate 9.

According to an exemplary construction relating to another particular variant of the assembly according to the invention and that can be combined with the features of the variant previously set out, the fixing of the dispensing device 1 to the cooling plate 9 comprises at least one weld of its fixing means 3. As an example, the weld is produced between one or more of the fixing interfaces 31 positioned at the ends of the staple of the fixing means 3 and the surface of the cooling plate 9. It should be noted that direct fixing alternatives can also be considered, like a fixing which comprises at least one adhesive composition.

Obviously, the invention is not limited to the embodiments described and/or represented in the attached drawings. Modifications remain possible, notably from point of view of the construction of the various elements or by the substitution of technical equivalents, without departing in any way from the scope of protection of the invention.

1-11. (canceled)

12. A dispensing device for dispensing heat-transfer fluid at circulation orifices of cooling plates, said dispensing device comprising:
one heat-transfer fluid duct comprising at least:
one dispensing orifice configured to be positioned facing at least one circulation orifice of a cooling plate, p2 one bearing surface configured to be of a form complementing the portion of the surface of the cooling plate which bears at least one circulation orifice, the bearing surface surrounding at least a part of the dispensing orifice of the duct,
one seal positioned along at least a part of the bearing surface of the duct, this seal being configured to seal the join of the dispensing orifice of the duct with a cooling plate,
a fixing means for fixing the duct to the surface of a cooling plate,
and in that the fixing means comprises a structure having the form of a staple arranged to surround at least a portion of the duct at a section, each of the two ends of the staple comprising a fixing interface configured to interact with at least a part of the surface of the cooling plate on which the fixing of the duct is done.

13. The heat-transfer fluid dispensing device as claimed in claim 12, wherein the bearing surface of the duct at which the seal is positioned comprises a recess capable of receiving at least a part of the seal.

14. The heat-transfer fluid dispensing device as claimed in claim 12, wherein at least a portion of the seal is produced in ethylene-propylene-diene monomer, in hydrogenated butadiene-acrylonitrile and/or in silicone.

15. The heat-transfer fluid dispensing device as claimed in claim 12, wherein, in section at a dispensing orifice intended to be positioned facing a cooling plate, the duct has a “U” form comprising a portion with a substantially semi-circular arrangement open toward the dispensing orifice that is intended to be partitioned by the surface of the cooling plate.

16. The heat-transfer fluid dispensing device as claimed in claim 12, wherein, in section at a portion of the duct not bearing any dispensing orifice, the duct has an arrangement that is totally partitioned, even substantially circular.

17. The heat-transfer fluid dispensing device as claimed in claim 12, wherein the fixing means comprises at least one tab bearing a fixing interface positioned on each side of the axis of the duct and level with the bearing surface of the duct.

18. The heat-transfer fluid dispensing device as claimed in claim 12, wherein the heat-transfer fluid duct comprises a covering structure for covering at least one circulation orifice of a cooling plate, this covering structure comprising a plurality of dispensing orifices.

19. An assembly comprising at least one dispensing device as claimed in claim 12, fixed to at least one cooling plate.

20. The assembly as claimed in claim 19, wherein at least one cooling plate is associated with a dispensing device positioned at the circulation orifices of each of its ends.

21. The assembly as claimed in claim 20, wherein the dispensing device is fixed to the cooling plate by welding of its fixing means.
